(19) United States
(12) Patent Application Publication
(10) Pub. No.: US 2024/0233564 A1
(43) Pub. Date: Jul. 11, 2024

(54) COMMUNICATION METHOD AND RELATED COMPUTER SYSTEM IN VIRTUAL ENVIRONMENT

(71) Applicant: ViewSonic International Corporation, New Taipei City (TW)

(72) Inventors: Ting-Ting Hsiao, New Taipei City (TW); Chih-Wei Lu, New Taipei City (TW); Po-Chun Hsu, New Taipei City (TW); Wen-Ju Chow, New Taipei City (TW); Shih-Chang Weng, New Taipei City (TW); Yun-Cheng Hsin, Kaohsiung City (TW); Yu-Zhen Huang, Yunlin County (TW)

(73) Assignee: ViewSonic International Corporation, New Taipei City (TW)

(21) Appl. No.: 18/371,459

(22) Filed: Sep. 22, 2023

(30) Foreign Application Priority Data
Jan. 7, 2023 (TW) 112100727

(51) Int. Cl. G09B 5/06; G06T 17/00; G09B 5/08; G09B 7/06

(52) U.S. Cl. CPC G09B 5/06; G06T 17/00; G09B 5/08; G09B 7/06

(57) ABSTRACT

A communication method in a virtual environment includes initiating, by a first user, a virtual classroom through an education Metaverse application program of a first user device; attending, by at least a second user, the virtual classroom through an education Metaverse application program of a second user device; activating, by the first user, a class teaching mode, such that the first user and at least the second user login a cloud streaming system through corresponding education Metaverse application program of the first user device and the second user device to represent a first Avatar and a second Avatar for communication in the virtual classroom; wherein the virtual classroom is configured to render a spatial audio in a three-dimensional (3D) space.

### BACKGROUND OF THE INVENTION

### 1. Field of the Invention

The present invention relates to a communication method and related computer system in virtual environment, more particularly, to a communication method and related computer system in virtual environment capable of improving interactivity.

### 2. Description of the Prior Art

Conventional remote learning or online learning provides unidirectional experiences, e.g. a lecture or teaching is delivered by a lecturer or teacher, the audiences or the students may only receive information or course contents. Therefore, the conventional remote learning or online learning lacks interactions and cooperation experiences. In addition, self-motivation and self-discipline are needed for the audiences or learners with the conventional remote learning or online learning to achieve effective learning.

Therefore, improvements are necessary to the conventional remote learning or online learning methods.

### SUMMARY OF THE INVENTION

In light of this, the present invention provides a communication method and related computer system in virtual environment with an immersive virtual environment to improve the interactions.

An embodiment of the present invention discloses a communication method in a virtual environment, comprises initiating, by a first user, a virtual classroom configured to render a spatial audio in a three-dimensional (3D) space through an education Metaverse application program of a first user device; attending, by at least a second user, the virtual classroom through an education Metaverse application program of a second user device; activating, by the first user, a class teaching mode, wherein the first user and at least the second user login a cloud streaming system through corresponding education Metaverse application program of the first user device and the second user device to represent a first Avatar and a second Avatar for communication in the virtual classroom.

Another embodiment of the present invention discloses a computer system, comprises a plurality of user devices, equipped with an education Metaverse application program; and a cloud streaming system, comprises a real-time video module, configured to provide a video streaming service; an audio module, configured to provide an audio streaming service; a connection platform module, configured to provide a multi-people connection service for the cloud streaming system; and a cloud login module, configured to provide the plurality of user devices to login the cloud streaming system and direct the plurality of user devices to at least one of the real-time video module, the audio module and the connection platform module; wherein after a first user initiates a virtual classroom through the education Metaverse application program of a first user device of the plurality of user devices, at least a second user attends the virtual classroom through the education Metaverse application program of a second user device of the plurality of user devices; the first user activates a class teaching mode, wherein the first user and at least the second user login the cloud streaming system through corresponding education Metaverse application program of the first user device and the second user device to represent a first Avatar and a second Avatar for communication in the virtual classroom; and wherein the virtual classroom is configured to render a spatial audio in a three-dimensional (3D) space.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a computer system according to an embodiment of the present invention.

FIG. 2 is a schematic diagram of an establishing flowchart of virtual scenes and avatars according to an embodiment of the present invention.

FIG. 3 is a schematic diagram of a communication method of a virtual environment according to an embodiment of the present invention.

FIG. 4, FIG. 5 and FIG. 6 are schematic diagrams of an operation interface of a remote management module according to an embodiment of the present invention.

### DETAILED DESCRIPTION

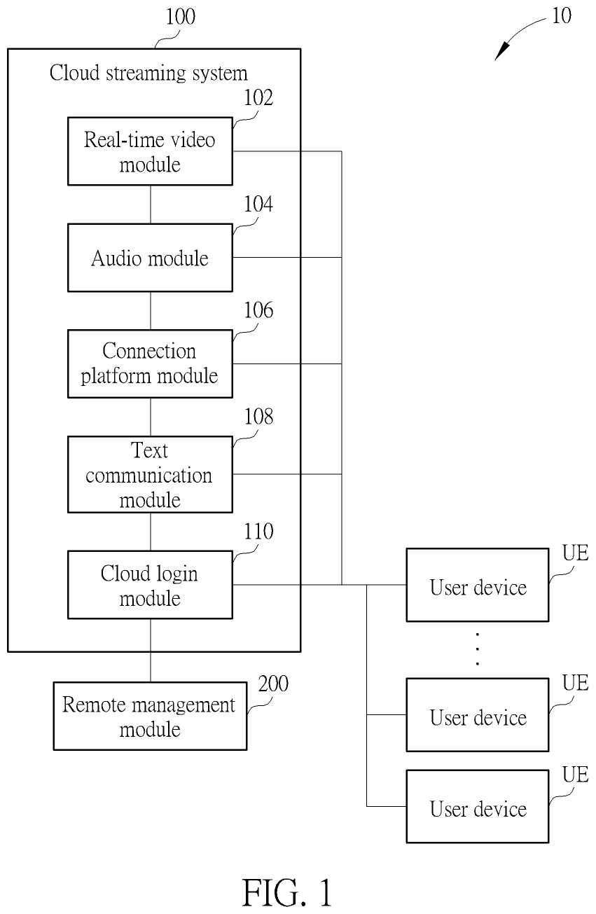

Please refer to FIG. 1, which is a schematic diagram of a computer system 10 according to an embodiment of the present invention. The computer system 10 includes a cloud streaming system 100, a remote management module 200 and a plurality of user devices UE. The cloud streaming system 100 includes a real-time video module 102, an audio module 104, a connection platform module 106, a text communication module 108 and a cloud login module 110. The remote management module 200 is utilized for storing data of the cloud streaming system 100 and data related to the user device UE. The user device UE may be equipped with an education Metaverse application program to login the cloud streaming system 100 through the cloud login module 110. Therefore, the education Metaverse application program of the user device UE and the cloud streaming system 100 may integrate a three-dimensional (3D) virtual environment and Avatars existing in the virtual environment to provide the user an immersive 3D virtual environment for online or remote learning.

The real-time video module 102 of the cloud streaming system 100 is configured to provide a video streaming service, e.g. LiveSwitch service platform or Web Real-Time Communication (WebRTC), for the users to communicate through videos. The audio module 104 is configured to provide an audio streaming service, e.g. Vivox service platform. In an embodiment, the education Metaverse application program of the user device UE may cooperate with the audio of physical space of the Vivox service platform, such that the user may experience the spatial audio in the virtual environment. The connection platform module 106 is configured to provide a multi-people connection platform module for the education Metaverse application program of the user device UE, e.g. Photon PUN service platform, such that multiple users may simultaneously connect to the platform in the virtual environment and interact with each other via the Avatars for online or remote learning. The text communication module 108 is configured to provide online texts, audio messages, emoticons or images for the users, e.g. Photon Chat service platform. The cloud login module 110 is configured to provide the user to login the cloud streaming system 100 and direct the users to above other service platforms, e.g. AWS cloud service platform.

In an embodiment, three-dimensional (3D) virtual environment and the Avatars in the virtual environment may be implemented by two-dimensional (2D) image graphic software, e.g. Photoshop software or 3D image graphic software, e.g. Maya software or Substance painter software, to establish Avatars corresponding to different users, animation of the Avatars and virtual scenes.

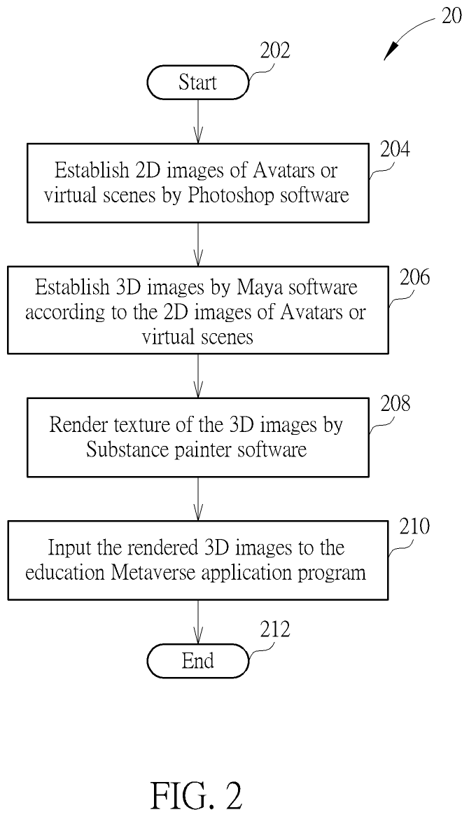

Please refer to FIG. 2, which is a schematic diagram of an establishing flowchart 20 of virtual scenes and avatars according to an embodiment of the present invention. The establishing flowchart 20 illustrates an establishing flowchart of the Avatar of each user device UE and virtual scenes in the education Metaverse application program. The establishing flowchart 20 includes the following steps: Step 202: Start;

Step 204: Establish 2D images of Avatars or virtual scenes by Photoshop software;

Step 206: Establish 3D images by Maya software according to the 2D images of Avatars or virtual scenes;

Step 208: Render texture of the 3D images by Substance painter software;

Step 210: Input the rendered 3D images to the education Metaverse application program; Step 212: End.

More specifically, in step 204, the Avatars or 2D virtual scenes are established by Photoshop software. Then, the 3D virtual images of the Avatars and the virtual scenes are established by 3D image graphic software, e.g. Maya software and Substance painter software, and the animations of the Avatars are established according to multiple 3D models in step 206 and step 208. The 3D images, established in step 210, are input to the education Metaverse application program through cross-platform software, e.g. Unity and Unity3D.

In this way, when the user logins the cloud streaming system 100 through the user device UE, the user may experience the Avatar and the virtual scenes in the education Metaverse application program. In addition, in an embodiment, the user may login the cloud streaming system 100 through different user devices UE, e.g. mobile devices, desktops or laptops to experience the Avatar and the virtual scenes in the education Metaverse application program.

Therefore, when the user initiates the education Metaverse application program on the user device UE, and logins the cloud streaming system 100, the user may see the Avatar corresponding to the user in the virtual environment, such that the user may perform communications and interactions via the real-time video module 102, the audio module 104, the connection platform module 106 and the text communication module 108. In such way, the education Metaverse application program and the cloud streaming system 100 may not only provide immersive 3D environment to improve the interactions between participated classmates and the teachers, but also achieve direct teaching and learning.

In an embodiment, a first user of the education Metaverse application program may be a teacher or an administrator, a second user may be a student or an auditor in the class. The first user may initiate a virtual classroom, such that at least a second user may respectively join the virtual classroom, wherein the virtual classroom is implemented by a spatial audio and a 3D space. As such, the first user and other second users may communicate with each other in the virtual classroom with Avatars, and experience the audio environment, which precisely reproduces the audio in the classroom, through the Avatar like in a physical class.

In the virtual classroom, the first user may initiate a class teaching mode, and the second users are allocated with seats. When the first user delivers the teaching, the second user must raise hand and acquire permission of the first user to speak or share his/her computer screen. Since the first user and the second user login the virtual classroom with the Avatars, all users may see the interactions of the Avatars of other users in the virtual classroom.

Furthermore, the first user may initiate a discussion teaching mode, and the second user may be allocated into groups in the virtual classroom for discussion through the real-time video module 102 and the audio module 104. The first user may join any group according to a group index for teaching and the first user may perform individual teaching for a second user through the real-time video module 102 and the audio module 104 in the groups, e.g. the first user may group a class with 20 people into 4 groups with 5 people, and join any group when the second users are in the groups for discussion. Moreover, the first user may initiate an independent discussion space without interference, which may be allocated to a group for discussion. The first user may determine a learning evaluation, i.e. point, according to a participation performance of the second user in the virtual classroom. In an embodiment, the second user may initiate an independent discussion space without interference for discussion before the first user initiates the class teaching mode.

In an embodiment, the participation performance may be at least one of an attendance, an attention and an interaction performance of the second user, wherein the attention refers to a time ratio of the second user concentrating in the virtual classroom, e.g. the user device UE includes a video camera, a computer screen, a keyboard and a mouse, the education Metaverse application program of the user device UE may determine the time ratio of the second user concentrating in the virtual classroom according to a time period of the second user staring the computer screen, whether or not a face of the second user is detected, whether or not an open/close state of eyes of the second user is detected, whether or not the face is moved or the keyboard/mouse is touched or moved.

More specifically, when a line of sight of the second user is off the computer screen for more than 20 seconds, the second user might be distracted, or when the face of the second user is not detected by the video camera for more than 20 seconds, the second user might be in front of the computer screen.

In addition, the interaction performance of the second user refers to at least one of a number of raising hands and a number of answering questions of the second user in the virtual classroom. More specifically, the education Metaverse application program of the user device UE may record and store activities or reactions of the second user in the virtual classroom in the remote management module 200. Therefore, the learning evaluation (point) of each of the second users may be determined according to the recorded content by the first user, and the second users may exchange accumulated points obtained from the virtual class for virtual objects or accessories of the Avatar.

The first user may pre-arrange a class schedule, a quiz and a course outline related to the virtual classroom on an operation interface of the remote management module 200 for convenience, and prepare a class of the virtual classroom, e.g. an English teacher may respectively pre-arrange an English lesson at 10 AM in morning and 2 PM in the afternoon on Monday. The first user may activate the quiz in the virtual classroom based on the pre-arranged quiz, e.g. questions and score allocations. In another embodiment of the present invention, the first user may provisionally arrange a quiz through the education Metaverse application program during the teaching, and determine corresponding learning evaluation (point) according to the quiz of the second user,

The class teaching mode, the discussion teaching mode or the discussion space provided by the education Metaverse application program of the user device UE may achieve instinct teaching, e.g. share computer screen, video conference representation, a digital whiteboard or a web browser, to improve the class participation. Since the virtual classroom is configured to render the spatial audio in the 3D space, the user may experience the immersive communication with the Avatar in the virtual classroom like in a physical classroom in person. The second user may perform digital corporations and discussions via real-time private messages, announcements, explanations, homework, notes and mutual comment tools with feedback to achieve a complete learning experience.

Notably, except pre-arranging editing curriculum or related information at the remote management module 200, i.e. a backstage of the education Metaverse application program, the first user or the administrator may edit members participating in the virtual classroom. In addition, only registered students or members can participate in the class, the participants cannot invite other people from different classrooms or schools or the public to join the class.

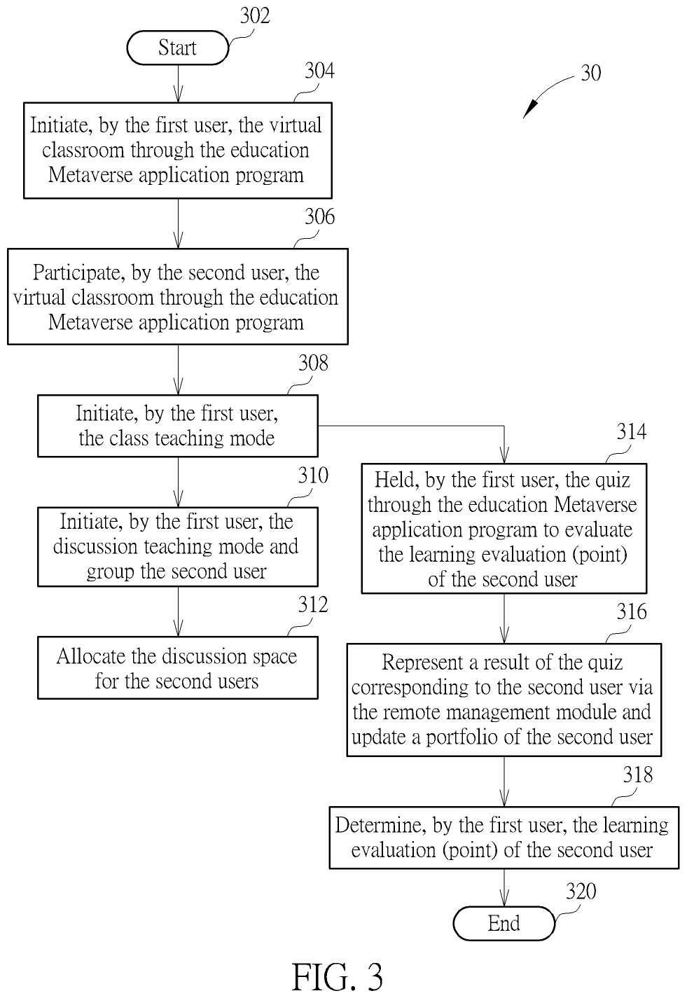

An operation flowchart of the education Metaverse application program may be concluded to a communication method 30 of the virtual environment, please refer to FIG. 3, which is a schematic diagram of the communication method 30 of the virtual environment according to an embodiment of the present invention. The communication method 30 of the virtual environment includes the following steps: Step 302: Start;

Step 304: Initiate, by the first user, the virtual classroom through the education Metaverse application program;

Step 306: Participate, by the second user, the virtual classroom through the education Metaverse application program;

Step 308: Initiate, by the first user, the class teaching mode;

Step 310: Initiate, by the first user, the discussion teaching mode and group the second user;

Step 312: Allocate the discussion space for the second users;

Step 314: Held, by the first user, the quiz through the education Metaverse application program to evaluate the learning evaluation (point) of the second user;

Step 316: Represent a result of the quiz corresponding to the second user via the remote management module and update a portfolio of the second user;

Step 318: Determine, by the first user, the learning evaluation (point) of the second user; Step 320: End.

Based on the communication method 30 of the virtual environment, the education Metaverse application program and the cloud streaming system 100 according to an embodiment of the present invention may provide the 3D immersive virtual environment for the users to improve the learning experience for the teachers and the students.

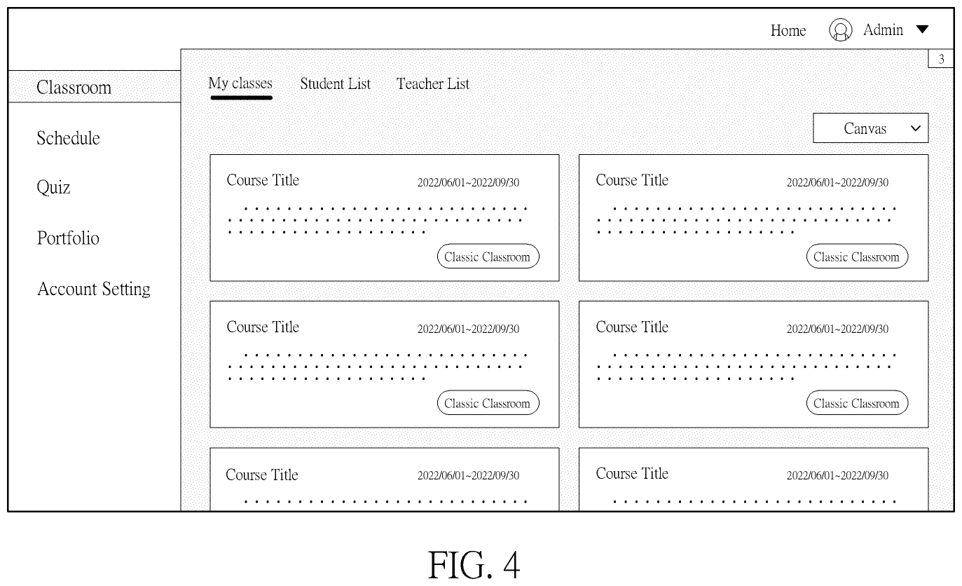

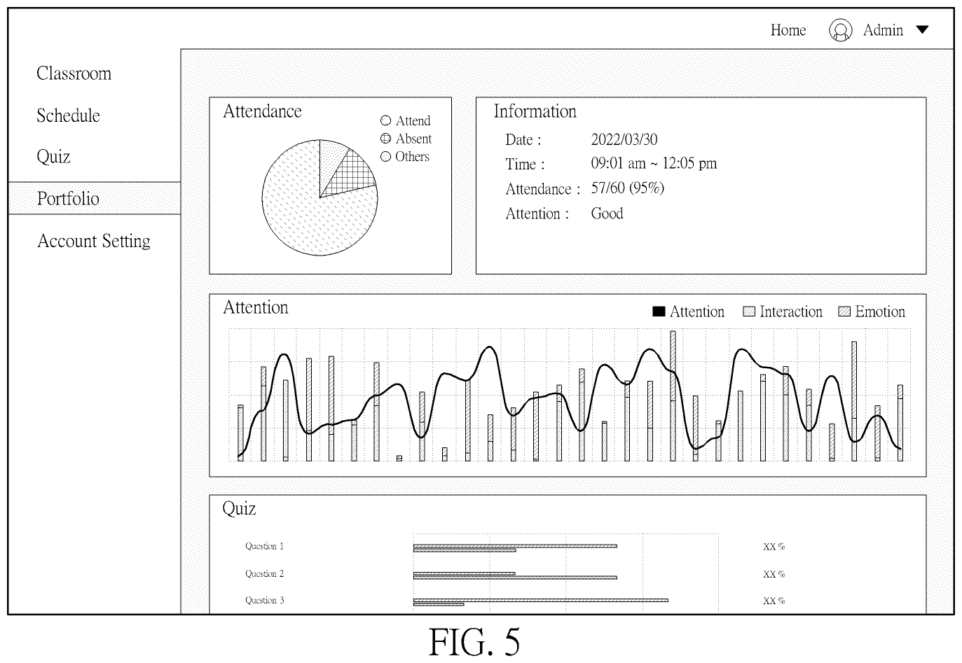

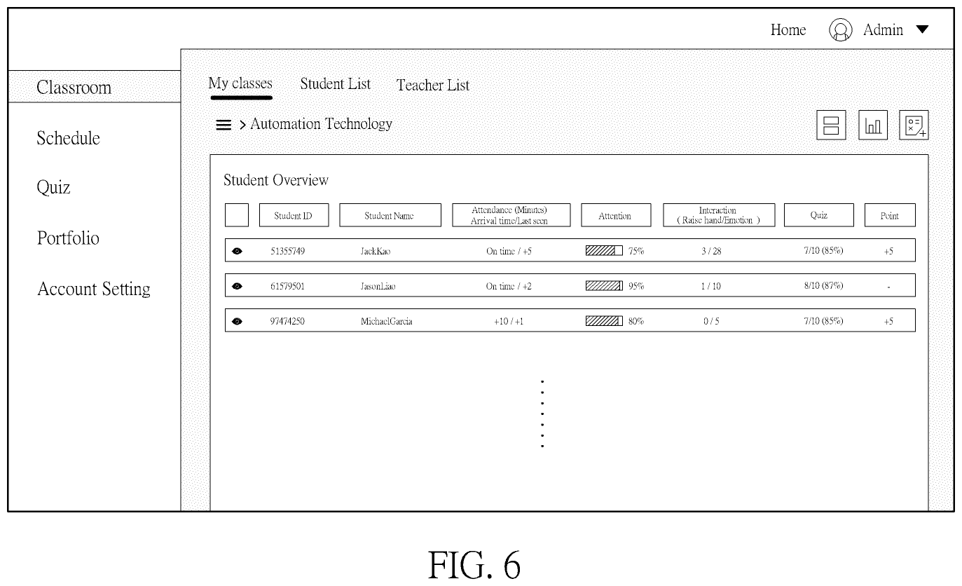

Please refer to FIGS. 4-6, which are schematic diagrams of different operation interfaces of the remote management module 200 according to an embodiment of the present invention. As illustrated in FIG. 4, the operation interface of the first user includes category labels: classroom, schedule, quiz, portfolio, account setting, wherein the classroom label may include different course titles, themes corresponding to different classes. Therefore, the remote management module 200 may integrate teaching with the management system to improve preparation of classes and management experiences of the first user.

FIG. 5 illustrates the contents of the portfolio, which includes personal information of the second user, the attendance (i.e. attend, absent or others), the attention and results of the quiz.

FIG. 6 illustrates another operation interface of the first user. Different to FIG. 4, the operation interface of FIG. 6 includes information of all second users, i.e. students, in the class, e.g. student identification (ID), name, the attendance, the attention, interaction, quiz and the learning evaluation (point). In addition, the above contents may be displayed with graphics to present a summary or overview of the second user.

Notably, the embodiments of the present invention illustrated above may be properly modified by people skilled in the art, and are not limited to the above examples. For example, software for implementing the spatial audio, the Avatar and virtual environment, and the evaluation of attention are not limited thereto and may be modified according to different requirements.

In summary, the present invention provides a communication method and related computer system in virtual environment, which integrates spatial audio, virtual Avatar, and virtual environment to improve the interactions between students and the teachers and integrate the teaching with the management system to access course contents and student portfolios in a more convenient way to achieve direct teaching and learning.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication method in a virtual environment, comprising:
initiating, by a first user, a virtual classroom configured to render a spatial audio in a three-dimensional (3D) space through an education Metaverse application program of a first user device;
attending, by at least a second user, the virtual classroom through an education Metaverse application program of a second user device;
activating, by the first user, a class teaching mode; wherein the first user and at least the second user login a cloud streaming system through corresponding education Metaverse application program of the first user device and the second user device to represent a first Avatar and a second Avatar for communication in the virtual classroom.

2. The communication method in the virtual environment of claim 1, further comprising:
determining, by the first user, a learning evaluation corresponding to at least the second user according to a participation performance of at least the second user in the virtual classroom.

3. The communication method in the virtual environment of claim 2, wherein the participation performance includes at least one of an attendance, an attention and an interaction performance of at least the second user.

4. The communication method in the virtual environment of claim 3, wherein the attention of at least the second user refers to a time ratio of at least the second user concentrating in the virtual classroom.

5. The communication method in the virtual environment of claim 3, wherein the interaction performance of at least the second user refers to at least one of a number of raising hands and a number of answering questions of at least the second user in the virtual classroom.

6. The communication method in the virtual environment of claim 2, further comprising:
pre-arranging, by the first user, a class schedule, a quiz and a course outline related to the virtual classroom on a remote management module; and
activating, by the first user, the quiz in the virtual classroom to evaluate the learning evaluation corresponding to at least the second user.

7. The communication method in the virtual environment of claim 2, further comprising:
arranging, by the first user, a quiz through the education Metaverse application program to evaluate the learning evaluation corresponding to at least the second user.

8. The communication method in the virtual environment of claim 1, further comprising:
activating, by the first user, a discussion teaching mode to group at least the second user for discussion, wherein the first user determines to join any group according to a group index.

9. The communication method in the virtual environment of claim 8, wherein the first user determines to activate a discussion space and assign at least the second user of any group to enter the discussion space for discussion.

10. The communication method in the virtual environment of claim 1, further comprising:
initiating, by at least the second user, a discussion space and entering the discussion space for discussion, before the first user activates the class teaching mode.

11. A computer system, comprising:
a plurality of user devices, equipped with an education Metaverse application program; and
a cloud streaming system, comprising:
a real-time video module, configured to provide a video streaming service;
an audio module, configured to provide an audio streaming service;
a connection platform module, configured to provide a multi-people connection service for the cloud streaming system; and
a cloud login module, configured to provide the plurality of user devices to login the cloud streaming system and direct the plurality of user devices to at least one of the real-time video module, the audio module and the connection platform module;
wherein after a first user initiates a virtual classroom through the education Metaverse application program of a first user device of the plurality of user devices, at least a second user attends the virtual classroom through the education Metaverse application program of a second user device of the plurality of user devices; the first user activates a class teaching mode;
wherein the first user and at least the second user login the cloud streaming system through corresponding education Metaverse application program of the first user device and the second user device to represent a first Avatar and a second Avatar for communication in the virtual classroom; and
wherein the virtual classroom is configured to render a spatial audio in a three-dimensional (3D) space.

12. The computer system of claim 11, wherein the cloud streaming system further includes a text communication module configured to provide a text, an audio message, an emoticon or an image conversation service.

13. The computer system of claim 11, wherein the computer system further comprises a remote management module, configured to provide the first user to pre-arrange a class schedule, a quiz, and a course outline related to the virtual classroom on the remote management module; and the first user determines to activate the quiz in the virtual classroom to evaluate a learning evaluation of at least the second user.

14. The computer system of claim 13, wherein the learning evaluation corresponding to at least the second user is determined by the first user according to a participation performance of at least the second user in the virtual classroom.

15. The computer system of claim 14, wherein the participation performance includes at least one of an attendance, an attention and an interaction performance of at least the second user.

16. The computer system of claim 15, wherein the attention of at least the second user refers to a time ratio of at least the second user concentrating in the virtual classroom.

17. The computer system of claim 15, wherein the interaction performance of at least the second user refers to at least one of a number of raising hands and a number of answering questions of at least the second user in the virtual classroom.

18. The computer system of claim 11, wherein the first user determines to activate a discussion teaching mode to group at least the second user for discussion, and the first user determines to enter any group according to a group index.

19. The computer system of claim 18, wherein the first user determines to activate a discussion space and assigns at least the second user of any group to enter the discussion space for discussion.

20. The computer system of claim 18, wherein the real-time video module and the audio module are configured to conduct video conferencing discussion in the discussion teaching mode.
